(19) United States
(12) Patent Application Publication
(10) Pub. No.: US 2013/0233652 A1
(43) Pub. Date: Sep. 12, 2013

(54) ELEVATOR SYSTEM WITH EMERGENCY OPERATION AND BACKUP POWER SUPPLY AT THE SAME LOCATION AS THE ELEVATOR DRIVE

(71) Applicants: Mourad Ghazi, Glen (FR); Stephane Despres, Gien (FR); Michel Beeuwsaert, Nevoy (FR)

(72) Inventors: Mourad Ghazi, Glen (FR); Stephane Despres, Gien (FR); Michel Beeuwsaert, Nevoy (FR)

(73) Assignee: OTIS ELEVATOR COMPANY, Farmington, CT (US)

(21) Appl. No.: 13/989,150

(22) PCT Filed: Dec. 2, 2010
(86) PCT No.: PCT/IB2010/003321

§ 371 Date: May 23, 2013

(51) Int. Cl. B66B 1/28; B66B 11/02; B66B 11/00

(52) U.S. Cl. CPC B66B 1/28; B66B 11/005; B66B 11/0226
USPC 187/290

(57) ABSTRACT

An exemplary elevator system includes an elevator car situated for movement within a hoistway. An elevator drive provides control over a position of the elevator car in the hoistway. A backup power source provides power when the primary power source is unavailable. An emergency controller uses power from the backup power source for controlling the position or movement of the elevator car within the hoistway when the primary power source is unavailable. The elevator drive, the emergency controller and the backup power source are all supported together in a single location within the hoistway.

### BACKGROUND

Elevator systems include a variety of components. With the introduction of machine roomless arrangements, new challenges are presented for locating those components. Elevator systems traditionally have been provided with a machine room above the hoistway that provided a convenient location for the machine and other control components. Without a machine room, the placement of components has to be more carefully thought out.

Some elevator systems are installed within a glass hoistway. In such elevator systems, the various components within the hoistway are visible. A glass hoistway is typically used for aesthetic reasons. Strategic placement of components within such a hoistway is required to maintain the aesthetic features that the glass hoistway is intended to provide.

### SUMMARY

An exemplary elevator system includes an elevator car situated for movement within a hoistway. An elevator drive provides control over operation of an elevator machine to control a position of the elevator car in the hoistway. A backup power source provides power when the primary power source is unavailable. An emergency controller uses power from the backup power source for controlling the position or movement of the elevator car within the hoistway when the primary power source is unavailable. The elevator drive, the emergency controller and the backup power source are all supported together in a single location within the hoistway.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 diagrammatically illustrates selected portions of an elevator system designed according to an embodiment of this invention.

FIG. 2 diagrammatically illustrates selected portions of another example elevator system designed according to an embodiment of this invention.

### DETAILED DESCRIPTION

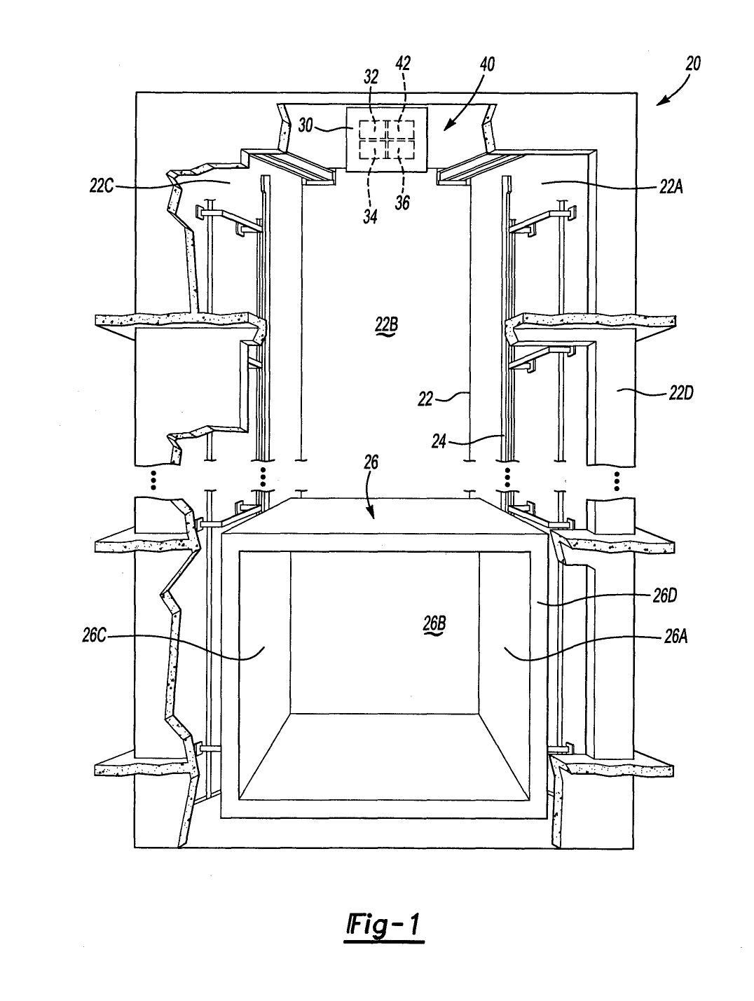

FIG. 1 shows selected portions of an example elevator system 20. A hoistway 22 includes guiderails 24 for guiding movement of an elevator car 26. This example includes a cabinet 30 for housing components that are used for controlling the position of the elevator car 26 within the hoistway 22. An elevator drive 32 operates in a known manner to control the operation of a machine (not illustrated) to realize a desired position and movement of the elevator car 26 within the hoistway 22. The elevator drive 32 relies upon power from a primary power source (e.g., a building power supply, not illustrated) and is used under most circumstances.

Occasionally, there may be a power loss to the building within which the elevator system 20 is installed. The illustrated example includes a backup or emergency controller 34 for controlling the position or movement of the elevator car 26 when power to the elevator drive 32 is unavailable from the primary power source. The emergency controller 34 comprises a rescue box that is useful for manual emergency rescue operation (“MRO”) and/or automatic rescue operation (“ARO”) in the event of a power loss, for example.

A backup power supply 36 is provided with the emergency controller 34 to provide power for ARO when the primary power source is unavailable. In one example, the backup power source 36 comprises one or more batteries.

One feature of the illustrated example is that the elevator drive 32, the emergency controller 34 and the backup power supply 36 are all within the single cabinet 30 so that they are all supported together in a single location in the hoistway 22. In this example, those components are all located near a top 40 of the hoistway 22.

Although the elevator drive 32, the emergency controller 34 and the backup power supply 36 are located within a single cabinet 30 in the illustration, it is not necessary that they all be in a single cabinet. It is desirable, however, to ensure that they are all at the same location within the hoistway 22.

The example of FIG. 1 also includes remote elevator system monitoring equipment 42 supported within the cabinet 30. The remote elevator system monitoring equipment 42 allows for remotely monitoring the condition or operation of the elevator system 20 in a known manner.

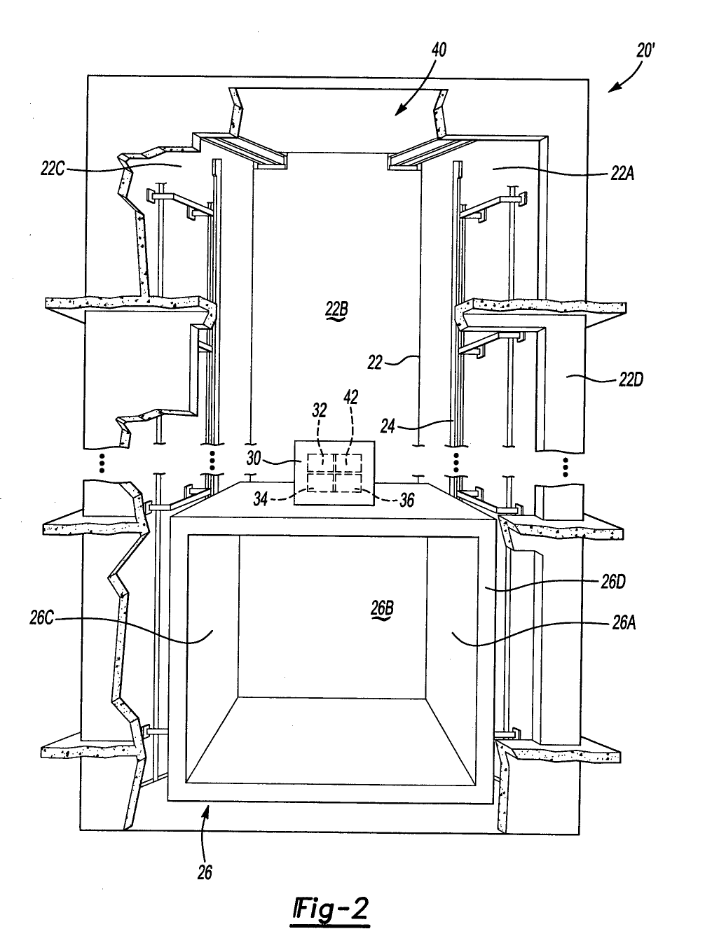

FIG. 2 illustrates another example elevator system 20′. In this example, the elevator drive 32, emergency controller 34, backup power supply 36 and remote elevator monitoring equipment 42 are all supported on top of the elevator car 26. In this example, all of those components are within a single cabinet 30. It is possible to use more than one housing or cabinet for those components provided that they are all at the same location within the hoistway, which in this case is on top of the elevator car 26.

While the example of FIG. 2 shows the example components supported on top of the elevator car 26, they may also be supported on a side or bottom surface of the car, depending on the particular configuration of a given elevator system.

One advantage of having the elevator drive 32, the emergency controller 34 and the backup power supply 36 all at a single location within the hoistway 22 or on the car 26 is that it allows a technician to have access to all of those components from a single position. Adding the remote elevator system monitoring equipment 42 at the same location provides a technician with further access to additional elevator system components at that same location.

Another advantage to the illustrated arrangement is that it allows for improving or preserving the aesthetics of a hoistway for situations where the interior of the hoistway is visible. For example, when the walls 22A, 22B, 22C, and/or 22D of the hoistway 22 and/or the walls 26A, 2613, 26C, and/or 26D of the car 26 are made of a transparent material (e.g., glass, fiberglass, etc.), having all of the example components in a single location avoids placing them at different locations along the hoistway, which improves the appearance of the elevator system to passengers within the car 26 and/or to individuals standing outside of the hoistway 22.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A machine roomless elevator system, comprising:
an elevator car situated for movement within a hoistway;
an elevator drive for controlling a position or movement of the elevator car in the hoistway, the elevator drive utilizing power from a primary power source;
a backup power source; and
an emergency controller that uses power from the backup power source for controlling the position or movement of the elevator car within the hoistway when the primary power source is unavailable, the backup power source, the elevator drive and the emergency controller all being supported together in a single location in the hoistway.

2. The system of claim 1, wherein the single location is near a top of the hoistway.

3. The system of claim 1, wherein the single location is on the elevator car.

4. The system of claim 3, wherein the single location is on top of the elevator car.

5. The system of claim 1, comprising
remote elevator monitoring equipment supported at the single location.

6. The system of claim 1, comprising a single cabinet that houses the backup power source, the elevator drive and the emergency controller.

7. The system of claim 1, wherein the emergency controller comprises a power supply rescue box for automatic rescue operation.

8. The system of claim 1, wherein one or more walls of the hoistway includes a transparent section.

9. The system of claim 8, wherein one or more walls of the car includes a transparent section.

10. The system of claim 2, wherein one or more walls of the hoistway includes a transparent section.

11. The system of claim 10, wherein one or more walls of the car includes a transparent section.

12. The system of claim 3, wherein one or more walls of the hoistway includes a transparent section.

13. The system of claim 12, wherein one or more walls of the car includes a transparent section.

14. The system of claim 5, wherein one or more walls of the hoistway includes a transparent section.

15. The system of claim 14, wherein one or more walls of the car includes a transparent section.
